(19) United States
(12) Patent Application Publication
(10) Pub. No.: US 2018/0210846 A1
(43) Pub. Date: Jul. 26, 2018

(54) FILES ACCESS FROM A NVM TO EXTERNAL DEVICES THROUGH AN EXTERNAL RAM

(71) Applicant: Hewlett Packard Enterprise Development LP, Houston, TX (US)

(72) Inventor: Andrew Brown, Houston, TX (US)

(21) Appl. No.: 15/415,437

(22) Filed: Jan. 25, 2017

(51) Int. Cl. G06F 13/16; G06F 13/40; G06F 13/42; G06F 9/44

(52) U.S. Cl. CPC G06F 13/1673; G06F 9/4406; G06F 13/4282; G06F 13/4068

(57) ABSTRACT

An example system that controls access to firmware files from a non-volatile memory to external devices through an external random access memory. The example disclosed herein comprises a processing unit coupled to a NVM controller that controls access to a NVM that stores external devices firmware files. The example also comprises external devices controllers coupled to the processing unit. The example further comprises a management controller coupled to the processing unit that comprises a RAM, external to the plurality of external devices, to receive the firmware files from the NVM and make the firmware files available to the external devices via the external device controller.

### BACKGROUND

In the art of computing, booting up is the initialization of a computerized system. A boot loader is the program that loads an operating system or some other system software for the computerized system after the completion of the power-on self-tests. The boot loader is loaded into main memory from persistent memory. The boot loader then loads and executes the process then finalizes the boot.

### DRAWINGS

Figures of the present disclosure depict examples, implementations, and configurations of the invention, and not the invention itself. The drawings descriptions are as follows:

FIG. 1 is a block diagram illustrating a system example for accessing files from a non-volatile memory to external devices through an external random access memory.

FIG. 2 is a flowchart of a method example for accessing files from a non-volatile memory to external devices through an external random access memory.

FIG. 3 is a block diagram illustrating a system example for accessing files from a non-volatile memory to external devices through an external random access memory.

### DETAILED DESCRIPTION

The following discussion is directed to various examples of the disclosure. The examples disclosed herein should not be interpreted, or otherwise used, as limiting the scope of the disclosure, including the claims. In addition, the following description has broad application, and the discussion of any example is meant only to be descriptive of that example, and not intended to intimate that the scope of the disclosure, including the claims, is limited to that example. In the foregoing description, numerous details are set forth to provide an understanding of the examples disclosed herein. However, it will be understood by those skilled in the art that the examples may be practiced without these details, While a limited number of examples have been disclosed, those skilled in the art will appreciate numerous modifications and variations therefrom. It is intended that the appended claims cover such modifications and variations as fall within the true spirit and scope of the examples, Throughout the present disclosure, the terms “a” and “an” are intended to denote at least one of a particular element. In addition, as used herein, the term “includes” means includes but not limited to, the term “including” means including but not limited to. The term “based on” means based at least in part on.

In the art of computing, booting up is the initialization of a computerized system. A boot loader is the program that loads an operating system or some other system software for the computerized system after the completion of the power-on self-tests. The boot loader is loaded into main memory from persistent memory. The boot loader then loads and executes the process than finalizes the boot.

Computerized systems comprise at least one processing unit. Some examples of processing units are microcontroller units (MCU) and central processing units (CPU). A microcontroller example is a system on a chip (SoC) and comprises both a processor (e.g. CPU), a memory and programmable input/output (I/O). A CPU by itself, does not include a memory and therefore an external memory may be required. Examples of standards for synchronous short-distance communication interface, mostly in embedded systems may be the Serial Peripheral Interface (SPI), Inter-Integrated Circuit (I2C), etc. SPI buses may be used to connect the different parts of a computerized system, such as the CPU and the memory. Computerized systems may be connected to a computer network through a Network Interface Controller (NIC), in other words, the NIC may be the interface that controls the connection between devices (e.g. computers, tablets, printers, televisions, servers etc.) to a network. Examples of NIC networks may be Ethernet, Wi-Fi, Fibre Channel, ATM, FDDI, Token ring, etc.

In some examples, the booting of a computerized system may start when power is applied to the microcontroller and, the microcontroller, comes out from reset and starts. This process may involve, in hardware, reading via SPI data. SPI data (e.g. booting up instructions) may be stored in a Read Only Memory (ROM), which is a non-volatile memory, and therefore the stored information is not lost if power is removed. ROM may be used for storing both, data and programs. Some examples of ROM may be Programmable Read-Only Memory (PROM), Erasable Programmable Read-Only Memory (EPROM), Electrically Alterable Read-Only Memory (EAROM), FLASH Memory, or Optical Storage Media (CD-ROM). In the present disclosure, the term ROM may be understood as not only as a BIOS/UEFI ROM components, but also other peripheral devices that may require ROM components/storage local for operations. The data (e.g. program stored in the ROM) may be copied to internal/external Random Access Memory (RAM) of the microcontroller in light of the fact that RAM is faster than ROM. After the completion of copying, the microcontroller starts (or jumps) and allows the execution of the program that has been copied to RAM.

Some system examples, may contain multiple microcontrollers. Some examples of microcontrollers may be NIC, storage microcontrollers, and main CPU. Each of the previous microcontrollers may undergo the same booting process, but with different SPI parts or programs. For example, the program for the NIC may be different from the program of CPU, due to the fact that the program for the NIC may come from a different SPI than the program of the CPU. The overall system may control the booting of the various microcontrollers (e.g. NIC first, storage second, and mail CPU third). Therefore, there may be a discrete power control of each microcontroller and device, and each may be powered on in sequence to achieve the booting of the system as a whole.

In large scale systems examples, many of the firmware components may be use the same computing instructions which are stored in the same component or components that, at the same time, may be replicated on each server, CPU, and/or module. This is a constraint to produce small designs, as there is a cost associated with this components, and there is difficulty in managing/updating them. The solution disclosed hereinafter allows for the virtualization of various components to a supporting infrastructure.

Some peripheral examples may not contain ROM (ROM-less devices), therefore using an external ROM to be updated (e.g. a system used an external DVD in order to load new/updated software). When powering on these peripherals, booting up instructions may be transferred from the external ROM to the internal RAM. Some examples transfer the booting up instructions through SPI FLASH devices. In a further example, a single ROM contains the booting up instructions of three peripherals, therefore one SPI FLASH device per peripheral is needed: a first SPI FLASH device may connect the first peripheral with the ROM, a second SPI FLASH device may connect the second peripheral with the ROM, and a third SPI FLASH device may connect the third peripheral to the ROM. Furthermore, the data may be transferred from a ROM, which is slower than RAM data transfer.

Examples disclosed herein provide an enhanced system for transferring data from an external non-volatile memory (NVM) (e.g. ROM) to a plurality of external devices virtualizing the SPI FLASH devices by means of a management controller coupled to the processing unit. In the present disclosure, an “external device” may be interpreted as a computerized system that requires at least one firmware file stored in an external ROM. The management controller comprises a RAM, for example a single RAM (e.g. buffer) to receive the plurality of firmware files (e.g. booting up instructions, stored variables values, stored parameters values, FLASH images, etc.) from the NVM and make these files available to the external devices. For example, as used herein, a “firmware file” refers to those files and programs written to the ROM of a computing device used to run said device. The present disclosure, not only improves the computing resource usage by virtualizing the plurality of SPI FLASH devices, but also the external devices receive the data (e.g. boot up instructions) faster as it is copied from a RAM.

The solution disclosed hereinafter allows the removal of FLASH components. The management controller and RAM allow for the centralization of images (e.g. firmware files). The solution allows for supporting infrastructure to virtualize the necessary images. These images may be shared in a single RAM for ease of management, change, upgrade and space savings. These images may also be unique when necessary if the components contain unique individual device information. This allows for efficient hardware fail-over mimicry, since all unique information (e.g. Machine Access Control address—MAC) are not stored in the hardware, but in the infrastructure.

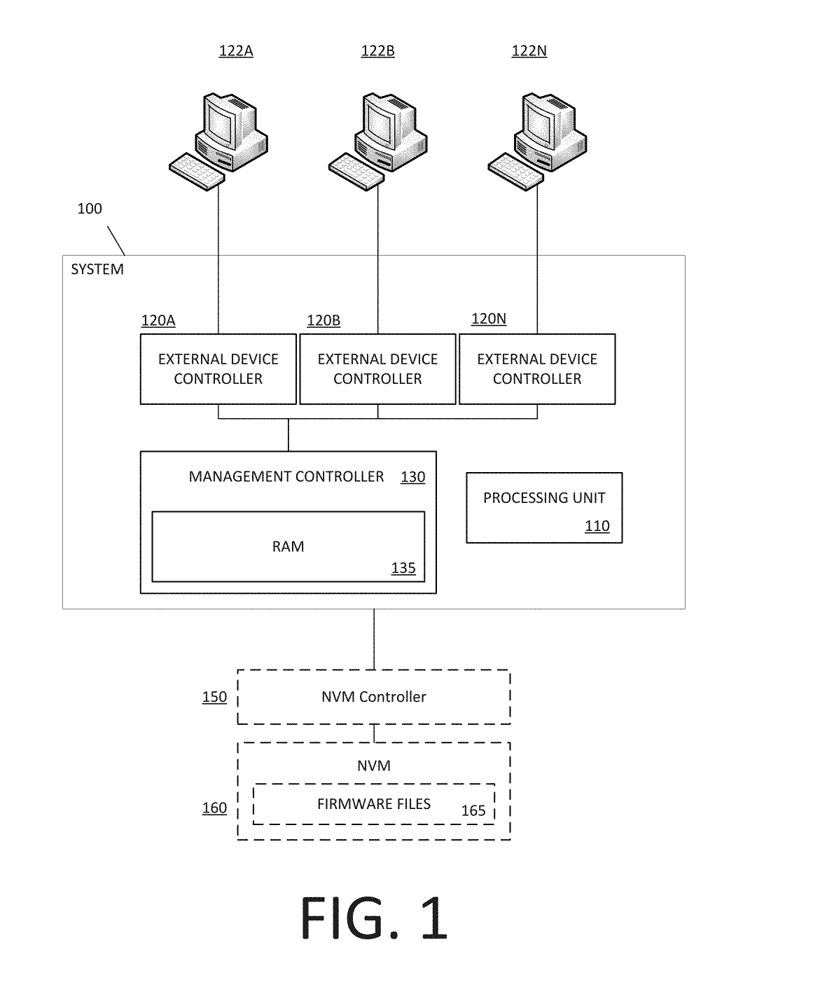

Referring now to the drawings, FIG. 1 depicts a block diagram illustrating a system for transferring firmware files from a non-volatile memory to a plurality of external devices through an external random access memory, according to an example of the present disclosure. The system comprises a management controller 130 a processing unit 110 (e.g. CPU, SoC) and a plurality of external device controllers 120A-120N.

The processing unit 110 comprises execution units and processor logic, and is coupled to the management controller 130. Note that memory controllers can be integrated into processors, with the processors providing the various signals required to access memory modules. The management controller 130 comprises a RAM 135 (e.g. a buffer). RAM 135 may be a memory space wherein data is stored temporarily, generally for a single use using a first in-first out system (FIFO). The management controller may be coupled to the plurality of external devices controllers 120A-120N. RAM 135 may be shared by all the external device controllers (120A-120N). The connection from the external devices controllers 120A-120N may be, a direct connection, an indirect connection, or a combination thereof. As used herein a direct connection may be understood as a connection between two elements (e.g. external device controllers 120A-120N to the management controller 130) without interconnection of a third element. In the present disclosure an indirect connection may be understood as a connection between two elements (e.g. external device controllers 120A-120N to the management controller 130) with interconnection of a third element. An example of a direct connection from an external device controller 120A-120N to a management controller 130 may be through a Serial Peripheral Interface (SPI) bus. The main use of RAM 135 may be to avoid that the requesting program or resource (e.g. external device controllers 120A-120N) may not run out of data due to process speed of an input/output (I/O) data transfer. The plurality of external devices controllers 120A-120N may be connected to a plurality of external devices of the same or different nature (e.g. computers, laptops, tablets, servers, etc.). An example of an external device controller may be a NIC, which allow communication from the device to a network (e.g. Ethernet, Wi-Fi, Fibre Channel, ATM, FDDI, Token ring, etc.) which speeds may range, for example, from 10 Mbit/s up to 160 Gbit/s. As an example, one external device controller may be connected to one external device at a time. For example, if a system comprises three external devices (e.g. ED1, ED2 and ED3) and, therefore, three external devices controllers (e.g. EDC1, EDC2, and EDC3); an example of the configuration would be ED1 coupled to EDC1, ED2 coupled to EDC2, and ED3 coupled to EDC3. The plurality of external device controllers 120A-120N may be also connected to the processing unit 110 and the management controller 130. The management controller 130 and the processing unit 110 may be also connected to an NVM controller 150 which, at the same time, is connected to a NVM 160 (e.g. ROM, HD, etc.). The NVM 160 may store firmware files 165 required by the plurality of external devices 122A-122N. Firmware files 165 examples may be instructions for running the plurality of external devices (e.g. booting up instructions, stored variables values, stored parameters values, etc.).

In the present example, the system disclosed hereinafter transfers a firmware file 165 to a requestor external device 122A-122N. Before any external device 122A-122N requires a firmware file 165, the processing unit 110 configures the NVM controller 150 to mimic the required firmware file 165 stored in the NVM 160 to the RAM 135. Then, at the spot time the external device 122A-122N requires the firmware file 165, the processing unit 110 configures the management controller 130 to send the firmware file 165 stored in the RAM 135 to the appropriate external device controller 120A-120N. Finally, the firmware file 165 is transferred through the network from the external device controller 120A-120N (e.g. NIC) to the requestor external device 122A-122N.

In the present disclosure, the term mimic may be interpreted as behaving similar to. The end result to the consumer (e.g. external device controller 120A-120N) is that no hardware or software had to change, but the implementation behind the scenes is different (e.g. external device controller 120A-120N may not change if the firmware file 165 comes directly from the NVM 160 or the RAM 135).

In a different example, more than one external devices 122A-122N request one or more firmware files 165 from the NVM 160. For example, the system may comprise four external devices (e.g. ED1, ED2, ED3, and ED4) connected to four external device controllers (EDC1, EDC2, EDC3 and EDC4); as a configuration example, ED1 may be connected to EDC1, ED2 may be connected to EDC2, ED3 may be connected to EDC3, and ED4 may be connected to EDC4. ED1 and ED2 require a firmware file 12 (FWF12), ED3 requires a firmware file 3 (FWF3), and ED4 requires both FWF12 and FWF3. The four external devices (ED1, ED2, ED3, and ED4) require two different files (FWF12 and FWF3) stored within the NVM 160 firmware files 165. Therefore, before any of the four external devices (ED1-ED4) requires the firmware files (FWF12 and FWF3), the processing unit 110 configures the NVM controller 150 to mimic FWF12 and FWF3 stored within the firmware files 165 from the NVM 160 to the RAM 135. Then, when the external devices (ED1-ED4) require the FWF12 and FWF3; the processing unit 110 configures the management controller 130 to transfer the FWF12 to EDC1, FWF12 to EDC2, FWF3 to EDC3, and both FWF12 and FWF3 to EDC4. Finally, FWF12 is transferred through the network from EDC1 to EC1, FWF12 is transferred through the network from EDC2 to EC2, FWF3 is transferred through the network from EDC3 to EC3, and both FWF12 and FWF3 are transferred through the network from EDC4 to EC4. In this example, five firmware files have been transferred (FWF12 to ED1, FWF12 to ED2, FWF3 to ED3, and both FWF12 and FWF3 to ED4) only mimicking two files in the RAM 135 (FWF12 and FWF2).

In a further example, the management controller 130 can be configured to instruct the NVM controller 150 to mimic from an external device (e.g. external device 122A) firmware files 165 to the RAM 135 when the external device 122A and the external device controller (e.g. external device controller 120A) are powered on.

As a different example, the management controller 130 can be configured to instruct the NVM controller 150 to mimic firmware files 165 (e.g. stored variables values, stored parameters values, booting up instructions, etc.) to the RAM 135 in various ways: look-up tables, dynamic configuration or other approaches. However, in general for its own nature, firmware files 165 may need to be known ahead in time, as any relationship defined or determine would suffice. In the present disclosure, the term look-up table may be understood in its computer science meaning. A look-up table may be an array that replaces runtime computation with a simpler array indexing operation. In other words, a look-up table may be understood as a data structure (e.g. vector, indexing vector, etc.) that is intended to replace a computation routine with a simple vector indexing operation. They may be useful so save processing time, since withdrawing a memory value is much faster than performing a big computation. A first example of the use of look up tables may be: Intel NICs of type XYZ use firmware files 165 from the NVM 160 (e.g. file_ABCD.bin). A second example of the use of look up tables may be: AMD NICs of type QRST use firmware files 165 from the NVM 160 (e.g. file_AMD_NIC_4534.bin). A third example of the use of look up tables may be: CPUs of type Intel and platform MNOP use firmware files 165 from NVM 160 (e.g. file_CPU_PROVIDER_System).

In order to optimize the computing resources used, RAM 135 may be sizeable. It would not be optimal to size the RAM 135 at the same size of the firmware files 165 mimicked. Due to the fact that the firmware files 165 stored in the RAM 135 may be only read once, it may be beneficial for the RAM 135 size to be smaller than the actual size of the firmware files 135 to be transferred. The RAM 165 may depend on the difference between the RAM 135 I/O data speeds. For example, the speed of the mimic of the firmware files 165 from the NVM 160 may not be as fast as the speed of the connection from the external device controller (120A-120N) to the management controller 130 (e.g. speed of the SPI bus). However, the speed of the mimic needs to be sufficiently fast that taking into account the SPI bus speed it may be guaranteed that the mimicked firmware files 165 in the RAM 135 are ready when the external device controller 120A-120N request them. For example, the external device controller 120A-120N may read in 512 byte sections (e.g. 000-511, 512-1023, 1024-1535, . . . , 65023-65535). Once the first section (000-511) has been read by the external device controller 120A-120N, the external device controller 120A-120N will not require that data again, due to the fact that it is reading/copying the first section of the firmware file 165 (000-511 bytes of the firmware file 165) into memory, and copying in a linear fashion. Then, the management controller 130 would read/obtain from the NVM 160/NVM controller 150 the necessary bytes to populate the 000-511 section are with the future firmware files 165 data that the external device controller 120A-120N will require, so that when the external device controller 120A-120N requires, the firmware file data 165 is already mimicked in RAM 135. The faster the data can be obtained from the NVM 150, the smaller the RAM 135 can be, as the easier it is for the data in the RAM 135 to be ready prior to the external device controller 120A-120N requests it. If the speed of obtaining data is as fast as or faster than the SPI bus (speed and latency), the RAM 135 can be sized up to two times the request size (512 bytes) and the RAM 135 may be filled to keep the external device controller 120A-120N satisfied with firmware files 165 data. However, if the speed of obtaining the firmware file 165 data is slower, then the size of the RAM 135 may be sized to guarantee that the difference in speed may still allow the external device controller 120A-120N to retrieve the firmware file 165 data from the RAM 135. On top of the previous discussion, the RAM 135 may be sized based on the mimic rate that keeps the RAM 135 full above a predetermined minimum RAM threshold level.

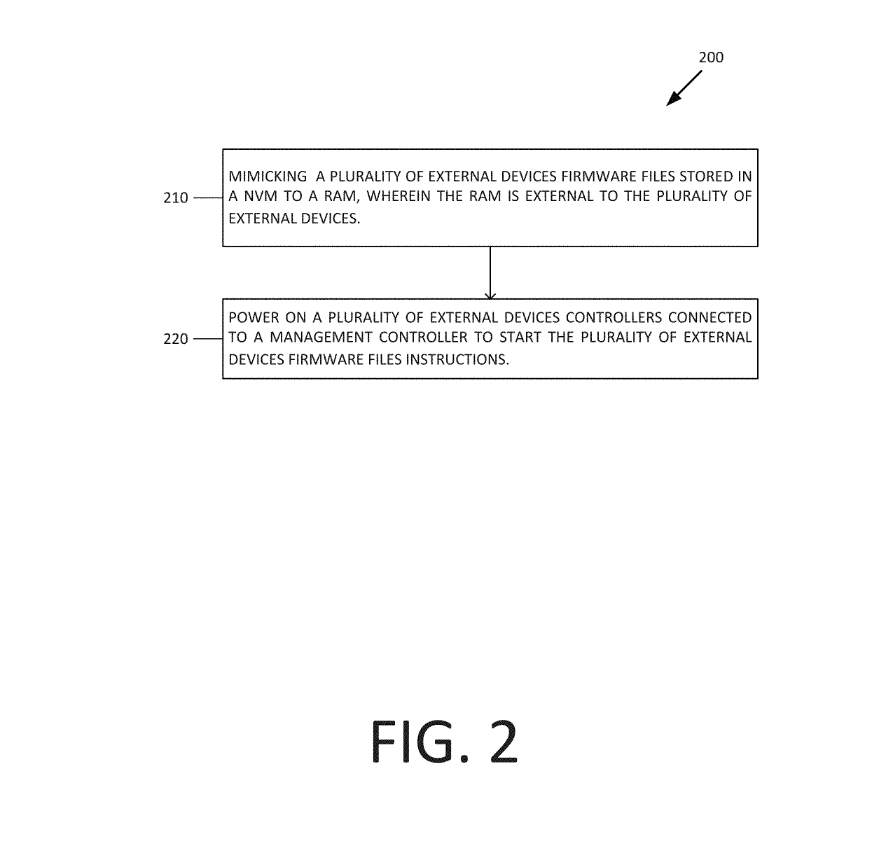

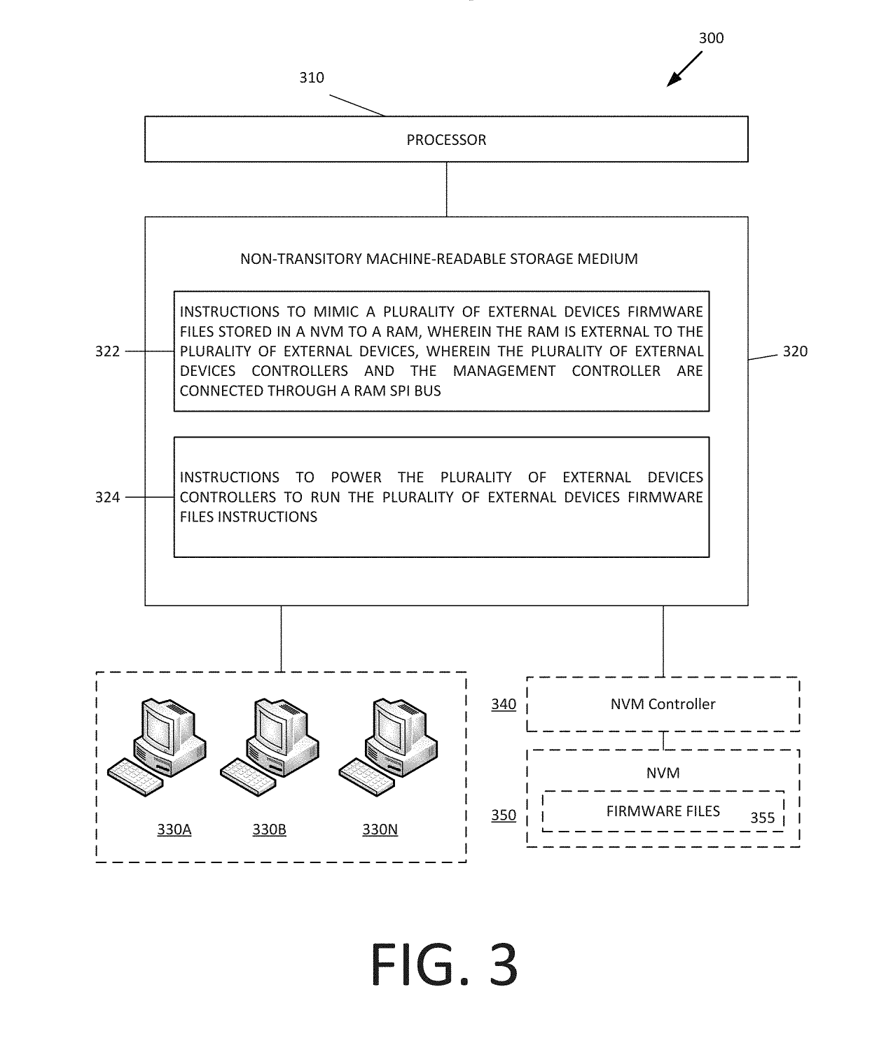

FIG. 2 is a flowchart of a method 200 for transferring firmware files from a non-volatile memory to a plurality of external devices through an external random access memory, according to an example of the present disclosure. Method 200 as well as the methods described herein can, for example, be implemented in the form of machine readable instructions stored on a memory of a computing system (see, e.g. the implementation of system 100 of FIG. 3), in the form of electronic circuitry or another suitable form. Method 200 may be used by system 100 from FIG. 1.

At block 210, the method 200 mimics a plurality of external devices firmware files stored in a NVM to a RAM, wherein the RAM is external to the plurality of external devices. The RAM may be smaller in size than of the plurality of firmware files size. However, the processing unit may retrieve the firmware file fast enough to keep the RAM full above a minimum RAM threshold level.

At block 220, the method 200 powers on a plurality of external devices controllers (e.g. NIC) connected to a management controller to start the plurality of external devices firmware files instructions. The management controller may be connected to the external device controller, for example, through a SPI bus.

FIG. 3 is a block diagram illustrating a system 300 for transferring firmware files 355 from a non-volatile memory 350 to a plurality of external devices 330A-330N through an external random access memory (RAM), according to an example of the present disclosure. FIG. 3 describes a system 300 that includes a physical processor 310 and a non-transitory machine-readable storage medium 320. The processor 310 may be a microcontroller, a microprocessor, central processing unit (CPU) core, an application-specific integrated circuit (ASIC), a field programmable gate array (FPGA), and/or the like. The machine readable storage medium 320 may store or be encoded with instructions 322 and 324 that may be executed by the processor 310 to perform the functionality described herein. System 300 may be connected to a plurality of external devices 330A-330N and to a NVM controller 340. The NVM controller 340 may be connected to a NVM 350. The NVM 350 may comprise firmware files 355. System 300 entities may be the same or similar as entities in system 100 of FIG. 1. System 300 may use the method 200 of FIG. 2.

In an example, the instructions 322 and 324, and/or other instructions can be part of an installation package that can be executed by processor 310 to implement the functionality described herein. In such a case, non-transitory machine readable storage medium 320 may be a portable medium such as a CD, DVD, or flash device or a memory maintained by a computing device from which the installation package can be downloaded and installed. In another example, the program instructions may be part of an application or applications already installed in the non-transitory machine-readable storage medium 320.

The non-transitory machine readable storage medium 320 may be any electronic, magnetic, optical, or other physical storage device that contains or stores executable data accessible to the system 300. Thus, non-transitory machine readable storage medium 320 may be, for example, a Random Access Memory (RAM), an Electrically Erasable Programmable Read-Only Memory (EEPROM), a storage device, an optical disc, and the like. The non-transitory machine readable storage medium 320 does not encompass transitory propagating signals. Non-transitory machine readable storage medium 320 may be allocated in the system 300 and/or in any other device in communication with the system 300.

In the example of FIG. 3, the management controller is linked to the processor 310. The instructions 322, when executed by the processor 310, cause the processor 310 to mimic a plurality of external devices firmware files 355 stored in a NVM 350 to a RAM, wherein the RAM is external to the plurality of external devices, wherein the plurality of external devices controllers and the management controller are connected through a SPI bus.

The RAM may have a smaller size than the plurality of external devices firmware files 355, therefore, system 300 may have further instructions that are executable by the processor 310 to cause the processor to retrieve the firmware files 355 fast enough to keep the RAM full above a minimum RAM threshold level.

In some examples, the system 300 may have further instructions executable by the processor 310 to cause the processor to instruct the NVM controller to mimic the plurality of firmware files 355 to the RAM based on look-up tables, dynamic configurations, or other approaches. As another example, the NVM may store a predetermined set of parameter values, the system 300 may have further instructions executable by the processor 310 to cause the processor to instruct the NVM controller to mimic the predetermined set of parameter values to the RAM based on a look-up table.

In the present disclosure, the term “parameter values” may be understood as any characteristic value that can help in defining or classifying a particular system (e.g. performance status, meaning an event, project, object, situation, etc.). Regardless the fact that both boot up instructions and parameter values may be considered as firmware files 355, the method for noticing the management controller to mimic them to the RAM may differ. When an external device 330A-330N requires a parameter value, the device may be powered on. On the contrary, when an external device 330A-330N requires boot up instructions, the device may be powered of. Hence, the method for noticing the management controller to mimic booting up instructions to the RAM may be through powering on the external device controller or through a look-up table. However, the method for noticing the management controller to mimic parameter values to the RAM may not be through powering on the external device controller, since the external device controller may be already powered on.

As a further example, the NVM 350 may include more than one version of the firmware file required by an external device (e.g. both FWF11 and FWF12 run external device 330A). The system 300 further comprise further instructions executable by the processor 310 to choose the most recently updated firmware file version based on the last update date from the plurality of firmware files.

As another example, the NVM 350 may include two versions of the same firmware files; an older version firmware files (e.g. FWF11A and FWF12A) and a recent version firmware files (e.g. FWF11B and FWF 12B). Then, two similar external devices require the previous firmware files (e.g. ED1 and ED2). However, ED1 is older and may not be compatible with the most recent version of the firmware files. ED2 may be compatible with the most recent version of firmware files. Then, using the method disclosed above, the system 300 will mimic both firmware files versions (FWF11A, FWF11B, FWF12A, and FWF12B) to the RAM, and then transfer FWF11A and FWF12A to ED1 and FWF11B and FWF12B to ED2.

The instructions 324, when executed by the processor 310, cause the processor 310 to power the plurality of external devices controllers to run the plurality of external devices firmware files 355 instructions.

The above examples may be implemented by hardware, firmware, or a combination thereof. For example the various methods, processes and functional modules described herein may be implemented by a physical processor (the term processor is to be interpreted broadly to include CPU, processing module, ASIC, logic module, or programmable gate array, etc.). The processes, methods and functional modules may all be performed by a single processor or split between several processors; reference in this disclosure or the claims to a “processor” should thus be interpreted to mean “at least one processor”. The processes, methods and functional modules are implemented as machine readable instructions executable by at least one processor, hardware logic circuitry of the at least one processors, or a combination thereof.

The drawings in the examples of the present disclosure are some examples. It should be noted that some units and functions of the procedure are not necessarily essential for implementing the present disclosure. The units may be combined into one unit or further divided into multiple sub-units. What has been described and illustrated herein is an example of the disclosure along with some of its variations. The terms, descriptions and figures used herein are set forth by way of illustration. Many variations are possible within the spirit and scope of the disclosure, which is intended to be defined by the following claims and their equivalents.

We claim that:

1. A computer system comprising:
a processing unit coupled to a non-volatile memory (NVM) controller, the NVM controller controlling access to a NVM storing a plurality of external device firmware files;
a plurality of external devices controllers coupled to the processing unit;
a management controller coupled to the processing unit, wherein the management controller comprises a Random Access Memory (RAM) to receive the plurality of firmware files from the NVM and make the plurality of firmware files available to the plurality of external devices via the plurality of external devices controllers, wherein the RAM is external to the plurality of external devices.

2. The computer system defined in claim 1, wherein the plurality of firmware files stored in the NVM comprise a set of instructions for running the plurality of external devices.

3. The computer system of claim 1, wherein the management controller is configured to instruct the NVM controller to transfer the plurality of firmware files based on a look-up table.

4. The computer system defined in claim 1, wherein the RAM is smaller in size than the size of the plurality of external devices firmware files.

5. The computer system defined in claim 4, wherein the management controller causes the processing unit to size the RAM based on the rate that keeps the RAM full above a minimum RAM threshold level.

6. The computer system defined in claim 1, wherein the plurality of external devices controllers is directly connected to the management controller.

7. The computer system defined in claim 6, wherein the plurality of external devices controllers and the management controller are connected through a Serial Peripheral Interface (SPI) bus.

8. The computer system defined in claim 1, wherein the RAM is a buffer.

9. A method comprising:
mimicking a plurality of external device firmware files stored in a non-volatile memory (NVM) at a random access memory (RAM), wherein the RAM is external to a plurality of external devices; and
powering on a plurality of external devices controllers connected to a management controller to start execution of the plurality of external devices firmware file instructions.

10. The method as defined in claim 9, wherein a first one of the external device controllers is a Network Interface Controller (NIC).

11. The method as defined in claim 9, wherein the external device controllers and the management controller are connected through a Serial Peripheral Interface (SPI) bus.

12. The method as defined in claim 9, wherein the RAM has a smaller size than one of the plurality of firmware files size.

13. The method as defined in claim 12, the method further comprising the processing unit retrieving the firmware file fast enough to keep the RAM full above a minimum RAM threshold level.

14. The method defined in claim 9, the method further comprising the management controller instructing the NVM controller to transfer the plurality of firmware files based on a look-up table.

15. A non-transitory machine-readable medium storing machine-readable instructions executable by a physical processor to cause the processor to:
mimic a plurality of external devices firmware files stored in a non-volatile memory (NVM) at a random access memory (RAM), wherein the RAM is external to the plurality of external devices, wherein the plurality of external devices controllers and a management controller are connected through a Serial Peripheral Interface (SPI) bus, wherein the external devices controllers are to execute the firmware files instructions during the power on.

16. The non-transitory machine-readable medium of claim 15, wherein the RAM has a smaller size than the plurality of firmware files, further comprising machine readable instructions that are executable by the processor to cause the processor to retrieve the firmware file fast enough to keep the RAM full above a minimum RAM threshold level.

17. The non-transitory machine-readable medium of claim 15, further comprising machine readable instructions that are executable by the processor to cause the processor to instruct the NVM controller to mimic the plurality of firmware files to the RAM based on a look-up table.

18. The non-transitory machine-readable medium of claim 15, wherein the NVM stores a predetermined set of parameter values, further comprising machine readable instructions that are executable by the processor to cause the processor to instruct the NVM controller to mimic the predetermined set of parameter values to the RAM based on a look up table.

19. The non-transitory machine-readable medium of claim 15, further comprising machine readable instructions that are executable by the processor to cause the processor to choose a most recently updated firmware file version based on the last update date from the plurality of firmware files.
